(19) United States
(12) Patent Application Publication
(10) Pub. No.: US 2003/0069008 A1
(43) Pub. Date: Apr. 10, 2003

(54) System information download method and mobile communication terminal

(75) Inventors: Takeo Nakazawa, Hino-shi (JP); Tatsuya Serita, Tachikawa-shi (JP)

Correspondence Address: BANNER & WITCOFF, 1001 G STREET N W, SUITE 1100, WASHINGTON, DC, 20001, US

(73) Assignee: Kabushiki Kaisha Toshiba, Minato-ku (JP)

(21) Appl. No.: 10/267,658

(22) Filed: Oct. 10, 2002

(30) Foreign Application Priority Data
Oct. 10, 2001 (JP) 2001-312984

(51) Int. Cl. H04M 3/00

(52) U.S. Cl. 455/419; 455/418

(57) ABSTRACT

When a server SV transfers a bootstrap message to a mobile communication terminal MS1, the bootstrap message is stored in a retry buffer of the mobile communication terminal MS1. Subsequently, when an IOTA feature is discontinued before a download start or in a download term, the IOTA feature is again executed based on the bootstrap message stored in the mobile communication terminal MS1 at a timing indicated by a retry timer.

### CROSS-REFERENCE TO RELATED APPLICATIONS

This application is based upon and claims the benefit of priority from the prior Japanese Patent Application No. 2001-312984, filed Oct. 10, 2001, the entire contents of which are incorporated herein by reference.

### BACKGROUND OF THE INVENTION

1. Field of the Invention

The present invention relates to a system information download method of downloading system information peculiarly used by a mobile communication terminal in a mobile communication system onto the mobile communication terminal, for example, from a server on the Internet, and to a mobile communication terminal which has a feature for carrying out the method.

2. Description of the Related Art

In general, in a mobile communication system, mobile communication terminals individually download system information such as a system identification list and a preferred roaming list from a server of a communication provider. Moreover, each mobile communication terminal selects a mobile communication system to be used based on the downloaded system information, establishes synchronization with the selected mobile communication system, and subsequently performs radio communication.

Additionally, the mobile communication terminal has heretofore downloaded the system information according to a protocol referred to as Over the Air (OTA) in conformity to TIA/EIA/TS-683A. However, in recent years, to dispose a provisioning server of a communication provider on the Internet and to download the system information by the mobile communication terminal from the server on the Internet have been studied. Moreover, IP based Over the Air (IOTA) has been proposed as a protocol for the downloading.

In IOTA, first the server of the communication provider generates a bootstrap message for booting an IOTA feature of the mobile communication terminal. Subsequently, the server transfers this bootstrap message to a short message service (SMS) center via the Internet. Moreover, the server uses, for example, a data burst message in conformity to IS-95 and user data in SMS message in conformity to IS-637 to transfer this bootstrap message to the mobile communication terminal as a boot object from the SMS center via a mobile communication network. On receiving the bootstrap message, the mobile communication terminal requires of the mobile communication network that a data communication link should be established with the server, for example, by dial-up connection. Subsequently, when the data communication link is established with the server, the mobile communication terminal transmits a notification of receiving signal of the bootstrap message as a download request to the server. On receiving the notification of receiving signal of the bootstrap message, the server then downloads the system information for the mobile communication terminal.

Additionally, IOTA needs improvement due to the following problem. That is, in the mobile communication system, if there is no vacant radio channel or satisfactory-quality radio channel cannot be seized, the data communication link cannot be established between the mobile communication terminal and server. Moreover, even when the data communication link is once established, the data communication link is sometimes disconnected. When the mobile communication terminal fails in the downloading of the system information, the IOTA feature is sometimes interrupted.

In this case, if the server cannot complete a download processing of the system information within a constant time from a transmission time of the bootstrap message, the server fails in the download processing of the system information to the mobile communication terminal for the present. Subsequently, after ending the download processing of the system information to other mobile communication terminals as download objects, the server again transmits the bootstrap message to the mobile communication terminal having failed in the download, and tries the downloading of the system information. On the other hand, when the downloading is unsuccessful, the mobile communication terminal returns to an idle state for the present. Subsequently, the bootstrap message arrives from the server in this state, and the IOTA feature is again booted in response to the bootstrap message.

Therefore, when the downloading of the system information to the optional mobile communication terminal once fails, a download timing of the system information with respect to the mobile communication terminal is much delayed. As a result, the mobile communication terminal cannot make an outgoing or incoming call or perform a hand off processing based on latest system information until the downloading of the system information is completed.

Moreover, when the server only once fails in the downloading of the system information with respect to the mobile communication terminal, the server has to retry a download control of the system information to the mobile communication terminal from the beginning, and a processing burden increases.

### BRIEF SUMMARY OF THE INVENTION

The present invention has been developed in consideration of the above-described circumstances, and an object thereof is to provide a system information download method and mobile communication terminal. Thereby, when a download feature of system information is failed, the download of the system information can quickly be resumed without waiting for a boot instruction from a server. Thereby, latest system information can be smoothly acquired, and the control burden of the server regarding a download processing can be greatly reduced.

To achieve the above-described object, according to an aspect of the present invention, there is provided a method of downloading system information on a mobile communication system to a mobile communication terminal for use in the mobile communication system, the system information being downloaded to the mobile communication terminal from a server via a computer network and mobile communication network, the method comprising:

transmitting a boot message to the mobile communication terminal from the server;

storing the boot message transmitted from the server in the mobile communication terminal;

transmitting a download request of the system information to the server from the mobile communication terminal based on the boot message transmitted from the server;

downloading the system information to the mobile communication terminal from the server based on the download request transmitted from the mobile communication terminal;

detecting whether or not downloading the system information is failed;

retransmitting the download request of the system information to the server from the mobile communication terminal based on the boot message stored, when downloading the system information is detected to be failed; and

downloading the system information to the mobile communication terminal from the server based on the download request resent from the mobile communication terminal.

Moreover, according to another aspect of the present invention, there is provided a mobile communication terminal for use in a mobile communication system including a feature for downloading system information on the mobile communication system to the mobile communication terminal from a server via a computer network and mobile communication network, the mobile communication terminal comprising:

a reception part configured to receive a boot message sent by the server;

a storing part configured to store the boot message received by the reception part;

a first reception control part configured to transmit a download request of the system information to the server based on the boot message received by the reception part, and receive the system information downloaded from the server based on the download request;

a first detecting part configured to detect whether or not downloading of the system information is failed by the first reception control part; and

a second reception control part configured to resend the download request of the system information to the server based on the boot message stored in the storing part, when the first detecting part detects the downloading of the system information to be failed, and receive the system information downloaded from the server based on the download request retransmitted.

Furthermore, according to yet another aspect of the present invention, there is provided a method of downloading system information on a mobile communication system to a mobile communication terminal for use in the mobile communication system, the system information being downloaded to the mobile communication terminal from a server via a computer network and mobile communication network, the method comprising:

transmitting a download request of the system information to the server from the mobile communication terminal;

downloading the system information to the mobile communication terminal from the server based on the download request transmitted from the mobile communication terminal;

detecting whether or not downloading the system information is failed;

retransmitting the download request of the system information to the server from the mobile communication terminal, when downloading the system information is detected to be failed; and

downloading the system information to the mobile communication terminal from the server based on the download request retransmitted from the mobile communication terminal.

Additionally, according to more another aspect of the present invention, there is provided a mobile communication terminal for use in a mobile communication system including a feature for downloading system information on the mobile communication system to the mobile communication terminal from a server via a computer network and mobile communication network, the mobile communication terminal comprising:

a first reception control part configured to transmit a download request of the system information to the server, and receive the system information downloaded from the server based on the download request;

a first detecting part configured to detect whether or not downloading of the system information by the first reception control part is failed; and

a second reception control part configured to retransmit the download request of the system information to the server, when the first detecting part detects the downloading of the system information to be failed, and receive the system information downloaded from the server based on the download request retransmitted.

Moreover, according to yet more another aspect of the present invention, there is provided a mobile communication terminal for use in a mobile communication system including a feature for downloading system information on the mobile communication system to the mobile communication terminal from a server via a computer network and mobile communication network, the mobile communication terminal comprising:

a reception part configured to receive a boot message sent by the server;

a storing part configured to store the boot message received by the reception part;

a first reception control part configured to transmit a download request of the system information to the server based on the boot message received by the reception part, and receive the system information downloaded from the server based on the download request;

a first detecting part configured to detect an error while the system information is downloaded; and

a second reception control part configured to resend the download request of the system information to the server based on the boot message stored in the storing part, when the first detecting part detects the error, and receive the system information downloaded from the server based on the download request retransmitted.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic structure diagram of a mobile communication system including a function of carrying out a system information download method according to one embodiment of the present invention.

FIG. 2 is a block diagram of a mobile communication terminal for use in the system shown in FIG. 1.

FIG. 3 is a flowchart showing a processing procedure and content of an IOTA main control program executed in a control part of the mobile communication terminal shown in FIG. 2.

FIG. 4 is a flowchart showing a processing procedure and content of a bootstrap message reception control program executed in the control part of the mobile communication terminal shown in FIG. 2.

FIG. 5 is a flowchart showing a processing procedure and content of an IOTA download control program executed in a step ST307 of FIG. 3.

FIG. 6 is a flowchart showing a processing procedure and content of an IOTA retry boot control program executed in step ST309 of FIG. 3.

FIG. 7 is a flowchart showing a processing procedure and content of an IOTA retry monitor control program executed in the control part of the mobile communication terminal shown in FIG. 2.

FIG. 8 is a flowchart showing a processing procedure and content of an IOTA retry stop control program executed in step ST311 of FIG. 2, step ST411 of FIG. 4, step ST604 of FIG. 6, and step ST706 of FIG. 7.

FIG. 9 is a sequence diagram showing a transmission and reception procedure of data among the mobile communication terminal, server, and SMS center.

### DETAILED DESCRIPTION OF THE INVENTION

A system information download method and mobile communication terminal according to an embodiment of the present invention will be described hereinafter with reference to the drawings.

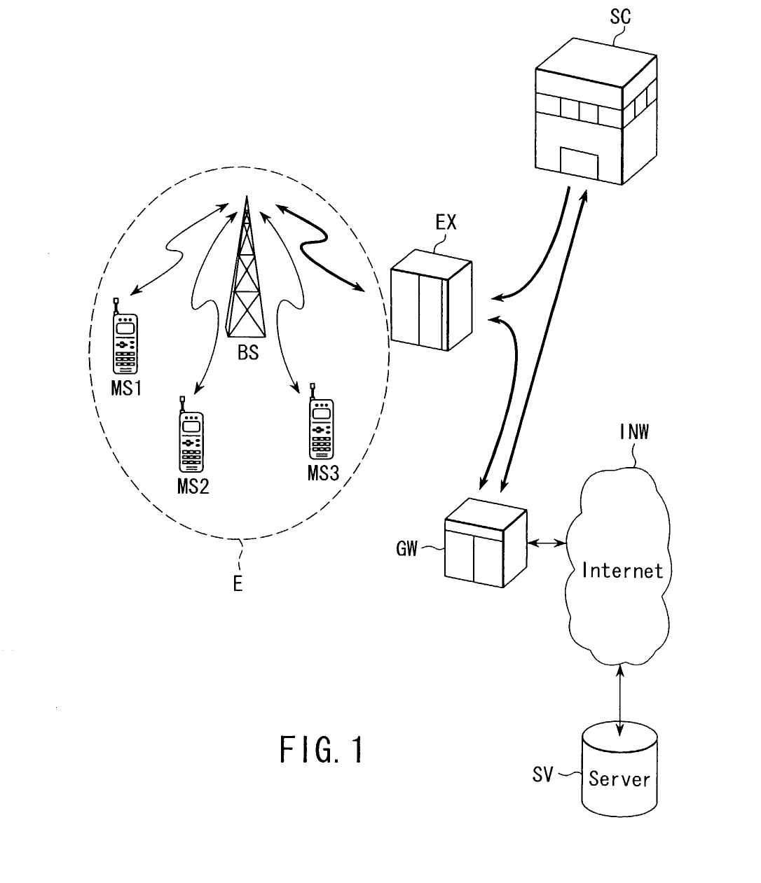

FIG. 1 is a schematic structure diagram of a mobile communication system including a function of carrying out the system information download method according to one embodiment of the present invention.

The system includes a plurality of base stations BS arranged in a service area. Additionally, in the drawing, for the simplicity of the description, only one base station BS is shown. The base station BS forms a radio area E called a cell, and is connected to mobile communication terminals MS1, MS2, and MS3 existing in the radio area E via a radio channel.

Moreover, the base station BS is connected to a mobile communication switching station EX via a wired line. The mobile communication switching station EX is connected to a short message service (SMS) center SC and provisioning gateway (hereinafter referred to as a gateway) GW. The SMS center SC generally controls the transfer of the short message among the mobile communication terminals MS1, MS2, and MS3. The gateway GW performs connection and communication control with a provisioning server (hereinafter referred to as the server) SV disposed on the Internet INW. The server SV has an IOTA feature for downloading the system information peculiar to the terminal with respect to the mobile communication terminals MS1 to MS3.

The system information may include not only a system identification list and preferred roaming list but also visual data and audio data. Examples of the visual data or audio data include incoming call melody data for notifying the mobile communication terminal of an incoming call, karaoke data, and the like.

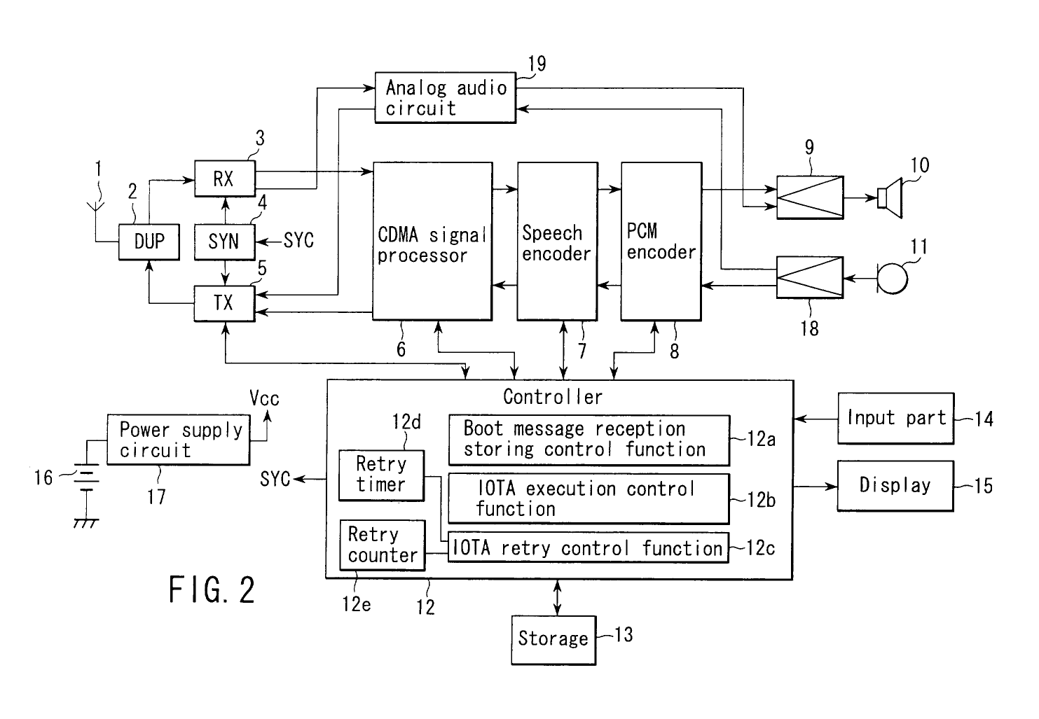

Additionally, the mobile communication terminals MS1, MS2, and MS3 are structured, for example, as follows. Each of the mobile communication terminals MS1, MS2, and MS3 is a multimode type terminal which can selectively use a digital mode using a code division multiple access (CDMA) system and an analog mode using an advanced mobile phone system (AMPS) system to perform the communication. FIG. 2 is a block diagram of the terminal.

A radio frequency signal transmitted from the base station BS is received by an antenna 1 and subsequently input into a reception circuit (RX) 3 via a duplexer 2 (DUP). In the reception circuit 3, the radio frequency signal is mixed with a received local oscillation signal output from a frequency synthesizer (SYN) 4 and frequency-converted to an intermediate-frequency signal or baseband signal. Additionally, the frequency of the received local oscillation signal generated from the frequency synthesizer 4 is indicated by a control signal SYC from a controller 12.

The received intermediate-frequency signal or received baseband signal is input into a CDMA signal processor 6, when a digital mode is set as a communication mode. On the other hand, when an analog mode is set, the intermediate-frequency signal or baseband signal is input into an analog audio circuit 19.

In the CDMA signal processor 6, the input received intermediate-frequency signal or received baseband signal is subjected to an orthogonal demodulation processing and a de-spreading processing by a spreading code (PN code) allocated to a reception channel. By this processing, demodulated data with a predetermined format is obtained in accordance with a data rate. The demodulated data is input into a speech encoder 7. Moreover, control data indicating the data rate in the demodulated data is input as a received data rate into the controller 12.

The speech encoder 7 subjects the demodulated data output from the CDMA signal processor 6 to an extension processing in accordance with the received data rate output from the controller 12, subsequently uses Viterbi decoding to perform a decoding processing and error correction decoding processing, and reproduces received digital data of the baseband.

A PCM encoder 8 performs a different signal processing in accordance with the type (speech communication or data communication) of digital audio signal communication output from the controller 12. That is, during the speech communication, the PCM encoder 8 decodes the received digital data output from the speech encoder 7 and outputs an analog receiving signal. This analog receiving signal is amplified by a receiving signal amplifier 9 and is subsequently output from a speaker 10. Moreover, during the data communication, the PCM encoder 8 supplies the received digital data output from the speech encoder 7 to the controller 12.

The controller 12 stores the received digital data in a storage 13 and displays the data on a display 15. Moreover, if necessary, the controller 12 outputs the received digital data to a portable data terminal (not shown) (such as a personal digital assistance (PDA)) or a personal computer such as notebook personal computer from an external interface.

On the other hand, the analog audio circuit 19 demodulates the input received intermediate-frequency signal by a frequency-modulation (FM) detector and reproduces the analog receiving signal. This analog receiving signal is amplified by the receiving signal amplifier 9 and subsequently output via the speaker 10.

On the other hand, speaker's input speech in the speech communication is input as an analog transmission signal through a microphone 11, and amplified to an appropriate level by a transmission amplifier 18. Moreover, when a digital mode is set as the communication mode, the transmission amplifier 18 outputs the input analog transmission signal to the PCM encoder 8. On the other hand, when an analog mode is set, the transmission amplifier 18 outputs the input analog transmission signal to the analog audio circuit 19.

The PCM encoder 8 subjects the input analog transmission signal to a PCM encoding processing. Thus generated transmission data is supplied to the speech encoder 7. Moreover, the data output from the personal computer (not shown) is input into the controller 12 via the external interface, and input into the speech encoder 7 from the controller 12 via the PCM encoder 8. Furthermore, transmission data generated in the controller 12 is also input into the speech encoder 7.

During the speech communication, the speech encoder 7 detects the energy amount of input speech from transmission audio data output from the PCM encoder 8, and determines the data rate based on the detected result. Subsequently, the speech encoder 7 compresses the transmission data into a burst signal with a format corresponding to the data rate, subjects the signal further to an error correction coding processing, and outputs the signal to the CDMA signal processor 6.

On the other hand, during the data communication, the speech encoder 7 compresses the transmission data output from the PCM encoder 8 into the burst signal with the format in accordance with the preset data rate, further subjects the signal to the error correction coding processing, and outputs the signal to the CDMA signal processor 6. Additionally, any data rate in the speech communication and data communication is output as a transmission data rate to the controller 12.

The CDMA signal processor 6 uses the PN code allocated to the transmission channel to subject the burst signal compressed by the speech encoder 7 to a spreading processing. Subsequently, the coded transmission signal is subjected to an orthogonal modulation processing, and the orthogonal modulation signal is output to a transmission circuit (TX) 5.

On the other hand, the analog audio circuit 19 uses an analog modulation system such as an FM modulation system to modulate a carrier signal based on the input analog transmission signal. The modulated carrier signal is output to the transmission circuit (TX) 5.

The transmission circuit 5 synthesizes the input orthogonal modulation signal or carrier signal with the transmission local oscillation signal generated by the frequency synthesizer 4 and converts the signal to a radio frequency signal. Moreover, the transmission circuit 5 amplifies only an effective component of the radio frequency signal at a high frequency based on the transmission data rate notified from the controller 12, and outputs a transmission radio frequency signal. The transmission radio frequency signal output from the transmission circuit 5 is supplied to the antenna 1 via the duplexer 2, and transmitted toward the base station (not shown) from the antenna 1.

An input part 14 includes a key group including a dial key, call origination key, power key, end key, volume control key, mode designation key, and the like. Moreover, the display 15 includes an LCD and LED. The LCD displays stored information of a telephone directory, outgoing or incoming call history, phone number of a terminal apparatus of a destination, operation state of a apparatus, and the like. Moreover, the LED displays a discharge state of a battery 16, that is, information requiring the charging of the battery 16.

Additionally, a power supply circuit 17 generates a predetermined operation power voltage Vcc based on an output of the battery 16 and supplies the voltage to each part. Moreover, the power supply circuit 17 also includes a charging circuit, and the charging circuit executes the charging of the battery 16.

Furthermore, the controller 12 includes a microcomputer as a main control part. As basic control functions, the controller 12 has a communication control function of executing a radio connection control in response to the outgoing or incoming call so that the speech communication or data communication is possible, a browser feature for accessing the Internet and displaying information such as a web page, system selection control function, idle hand off function, position registration control function, and the like.

Moreover, in addition to these basic control functions, as new functions according to the embodiment of the present invention, the controller has a boot message reception storing control function 12a, IOTA execution control function 12b, and IOTA retry control function 12c.

With arrival of an SMS message from the server SV in the idle state, the boot message reception storing control function 12a determines whether or not a control message inserted in the SMS message is a bootstrap message. Moreover, with the bootstrap message the boot message reception storing control function 12a regards this message as the boot message of the IOTA feature, notifies the IOTA execution control function 12b of the message, and stores the message in a buffer for the IOTA feature reboot in the controller 12.

In response to the bootstrap message notified from the boot message reception storing control function 12a, the IOTA execution control function 12b requires of the mobile communication switching station EX that a data communication link with the server SV should be established by dialup. Subsequently, when the data communication link with the server SV is established, the IOTA execution control function 12b transmits a notification of receiving signal of the bootstrap message as a download request of the system information to the server SV, subsequently receives the system information downloaded from the server SV in response to the request, and stores the information in the storage 13.

The IOTA retry control function 12c monitors a connection request operation of the data communication link by the IOTA execution control function 12b, and a download operation of the system information. The IOTA retry control function 12c detects the discontinuation of the IOTA feature by connection failure of the data communication link, failure of the download, or disconnection of the data communication link. Subsequently, when detecting the IOTA feature to be discontinued, the IOTA retry control function 12c requires the establishment of the data communication link with the server SV with respect to the mobile communication switching station EX in response to the bootstrap message stored in the buffer for IOTA reboot following a timing designated by a retry timer. Subsequently, the IOTA retry control function 12c performs a reception operation of the system information downloaded from the server SV.

An operation of the IOTA feature of the mobile communication system and mobile communication terminal structured as described above will next be described. Additionally, here, the downloading of the system information to a mobile communication terminal MS1 from the server SV will be described as an example.

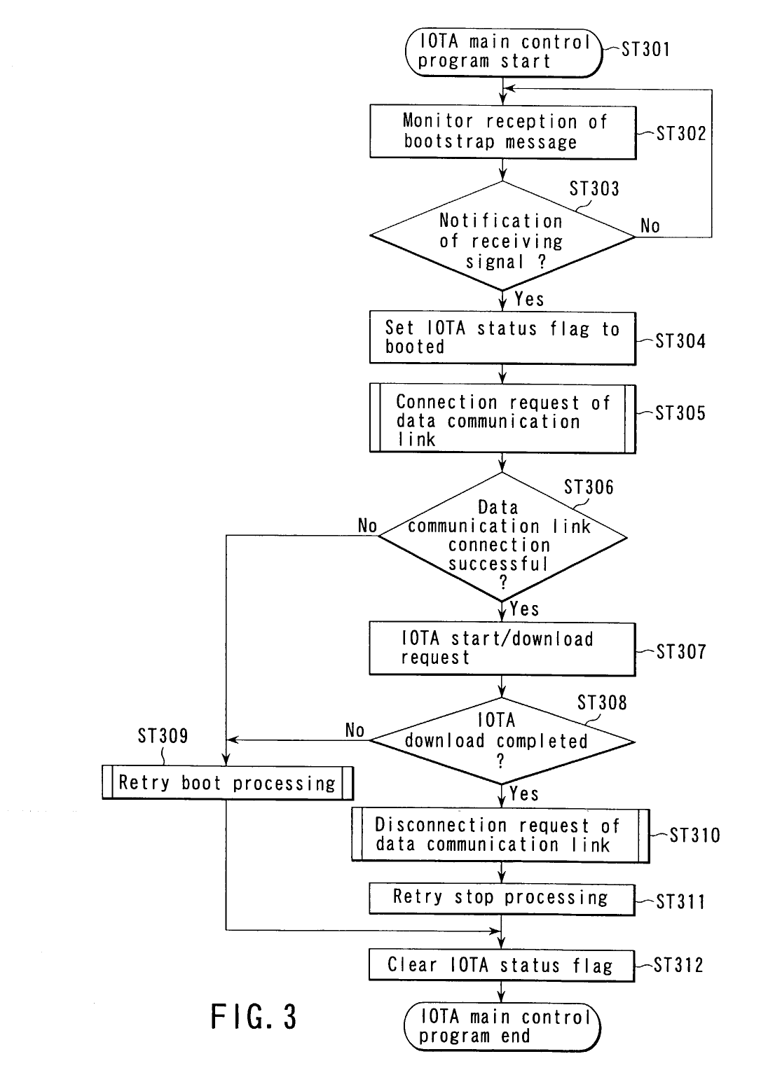

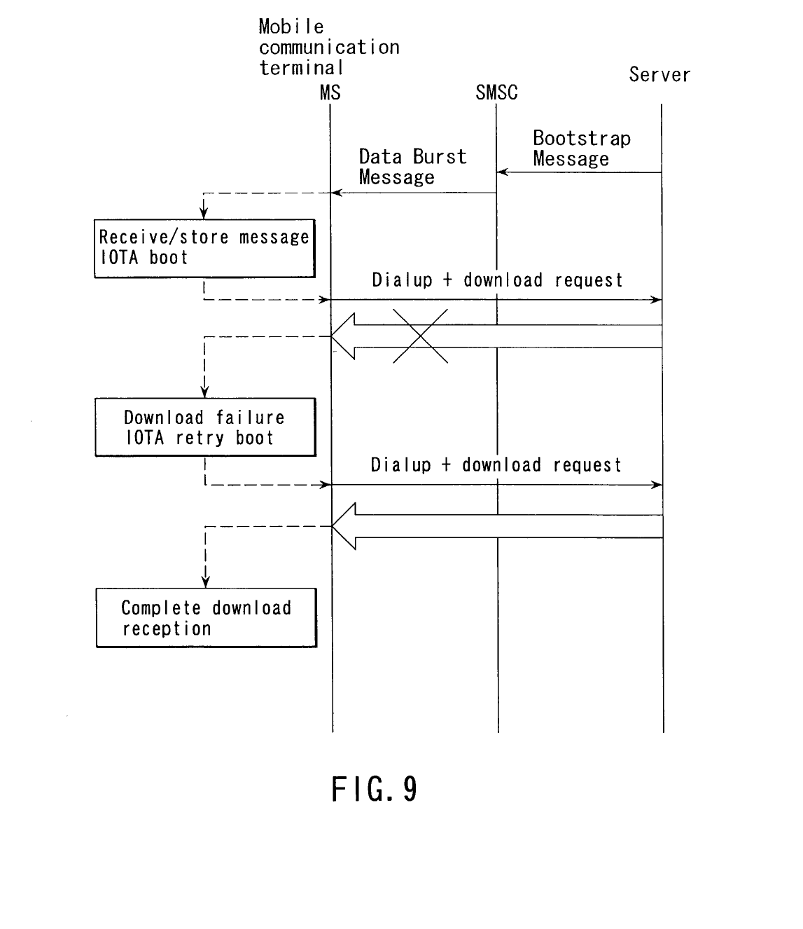

FIG. 3 is a flowchart showing a processing procedure and content of a main control program of IOTA feature in the mobile communication terminal MS1, and FIG. 9 is a sequence diagram showing a transmission and reception procedure of data among the mobile communication terminal MS1, server SV, and SMS center SC.

To download the system information by the IOTA feature, first the server SV generates the bootstrap message for booting the IOTA feature of the mobile communication terminal. The generated bootstrap message is transferred to the SMS center SC via the Internet INW and gateway GW as shown in FIG. 9. The SMS center SC uses, for example, a data burst message in conformity to IS-95 and user data in an SMS message in conformity to IS-637 to transmit the transferred bootstrap message to the mobile communication terminal MS1 as a boot object. The SMS message with the bootstrap message inserted therein is transferred to the mobile communication terminal MS1 via the mobile communication switching station EX and base station BS.

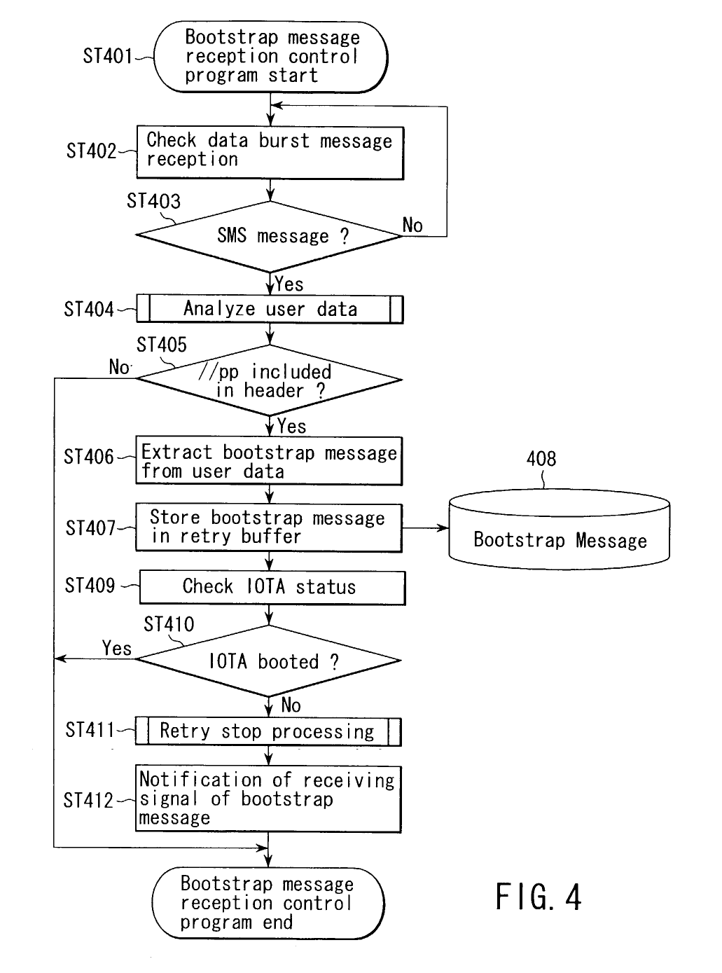

The mobile communication terminal MS1 monitors the arrival of the bootstrap message transmitted as the boot message of the IOTA feature from the base station periodically in the idle state in step ST302. FIG. 4 is a flowchart showing a processing procedure and content of a bootstrap message reception control program.

On receiving the execution request and starting the processing in step ST401, the controller 12 of the mobile communication terminal MS1 first checks of the reception of the data burst message in step ST402, and determines in step ST403 whether or not the received data burst message is an SMS message. As a result of the determination, the received data burst message is the SMS message. Then, in step ST404 the user data in the SMS message is analyzed. Additionally, when the received data burst message is not the SMS message, the processing returns to the step ST402 of checking the reception of the data burst message.

In the analysis of the user data in the SMS message, it is determined whether or not the message inserted in the user data is the bootstrap message. This bootstrap message is determined by whether or not “//pp” is included in a header. As a result of the determination, “//pp” is included in the header. Then, the controller 12 recognizes that the received message is the bootstrap message in step ST405, and shifts to step ST406 to extract the bootstrap message from the user data. Subsequently, the extracted bootstrap message is stored in a retry buffer (408 in FIG. 4) for IOTA reboot in the controller 12 in step ST407. Additionally, when the received SMS message is not the bootstrap message, the processing by the reception control program of the bootstrap message is ended.

When the storing processing of the bootstrap message ends, the controller 12 subsequently checks the IOTA status in step ST409. In the status check, based on the state of an IOTA status flag stored in a memory of the controller 12, it is determined whether or not the IOTA is booted. When IOTA is not booted, the controller 12 shifts to step ST411 from step ST410. Moreover, after the stop processing of the retry is indicated in the IOTA retry stop control program, the reception of the bootstrap message is notified with respect to the main control program shown in FIG. 3 in step ST412. On the other hand, when the IOTA feature is already booted, the processing by the reception control program is ended without performing the notification of receiving signal of the bootstrap message.

The processing shown in FIG. 4 is performed in parallel with the processing shown in FIG. 3. In step ST302, the result of the processing shown in FIG. 4 is referred to.

The controller 12 determines in step ST303 whether or not there is notification of a reception signal of the bootstrap message. When there is the notification of reception signal, the processing advances to step ST304. On the other hand, when there is no notification of reception signal, the controller returns to the step ST302 to monitor the arrival of the bootstrap message.

When there is notification of reception signal of the bootstrap message, the IOTA status flag is set to “IOTA booted” (step ST304), and the request processing for establishing the data communication link with the server SV is performed in step ST305. This establishment request processing of the data communication link is performed by dialup with respect to the mobile communication switching station EX.

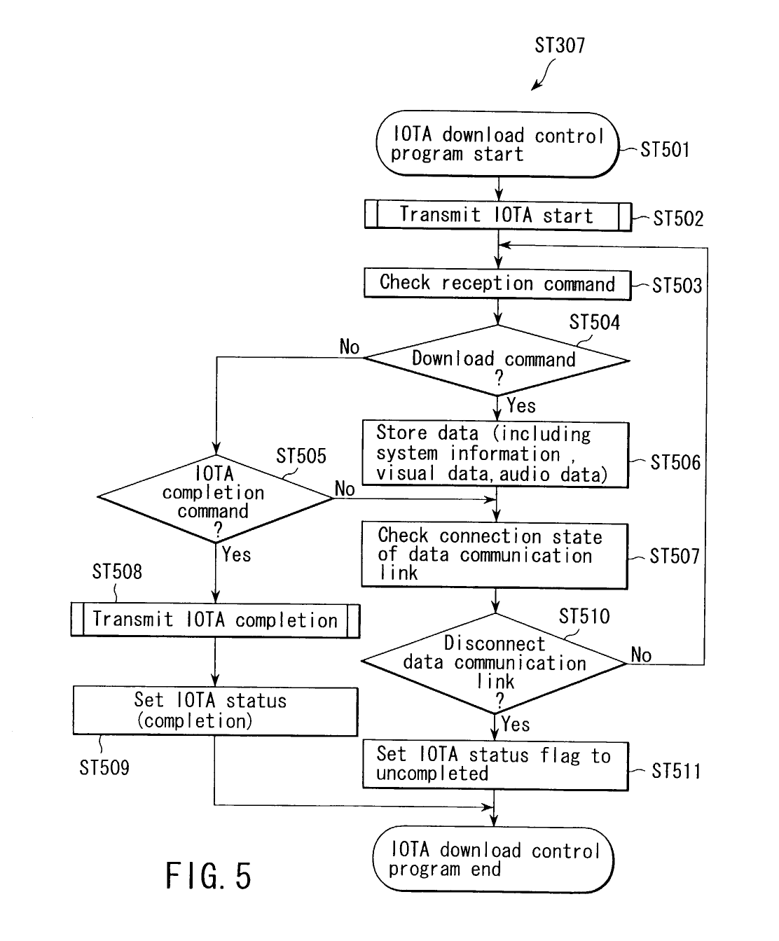

Subsequently, when the data communication link is established with the server SV, the controller 12 shifts to step ST307 from step ST306 to require the execution of IOTA download processing program. FIG. 5 is a flowchart showing a processing procedure and content of the IOTA download processing program. FIG. 5 shows the processing procedure and content of the IOTA download control program executed in step ST307 of FIG. 3.

On receiving the execution request and starting the processing in step ST501, the controller 12 first transmits an IOTA start request (download request) to the server SV in step ST502. Subsequently, the controller checks a command transmitted from the server SV in step ST503, and determines in step ST504 whether the reception command is a download command of the system information.

As a result of the determination, when the reception command is the download command, in step ST506 the system information downloaded from the server SV is received and stored in the storage 13. Moreover, during download, the connection state of the data communication link is checked in step ST507. When the data communication link is normal, the controller returns to step ST503 from step ST510 and repeats the download processing of the data. On the other hand, when disconnection of the data communication link is detected during data download, the controller 12 shifts to step ST511 from step ST510 to set the IOTA status flag to “uncompleted”, and returns to the main control program shown in FIG. 3.

Moreover, when the command received during the data download is a completion command, not the download command (steps ST504 and ST505), the controller 12 shifts to step ST508 from step ST505, and transmits the download completion of the system information to the server SV. Subsequently, the controller sets the IOTA status flag to “completed” in step ST509, and returns to the main control program shown in FIG. 3.

On returning to the processing of the main control program, the controller 12 detects whether or not the download of the system information by the IOTA feature is completed in step ST308. In the detection, it is checked whether the IOTA status flag is set to “completed” or “uncompleted”. Moreover, when the download of the system information is completed, the controller shifts to step ST310 to require the disconnection of the data communication link with respect to the mobile communication switching station EX here. Subsequently, when the data communication link is disconnected, in step ST311 a stop processing of IOTA retry is performed, further in step ST312 the IOTA status flag is cleared, and the processing of the main control program is ended.

On the other hand, in a connection determination processing (step ST306) of the data communication link, it is assumed that the data communication link cannot be established. Reasons why the data communication link cannot be established are that there is no vacant radio channel and that the quality of the radio channel is degraded. In this case, the controller 12 shifts to step ST309 to require the execution of IOTA retry boot processing program.

Moreover, even when the controller 12 determines the IOTA to be uncompleted by the determination of completion or incompletion of IOTA in step ST308, the controller shifts to the step ST309 to require the execution of the IOTA retry boot control program.

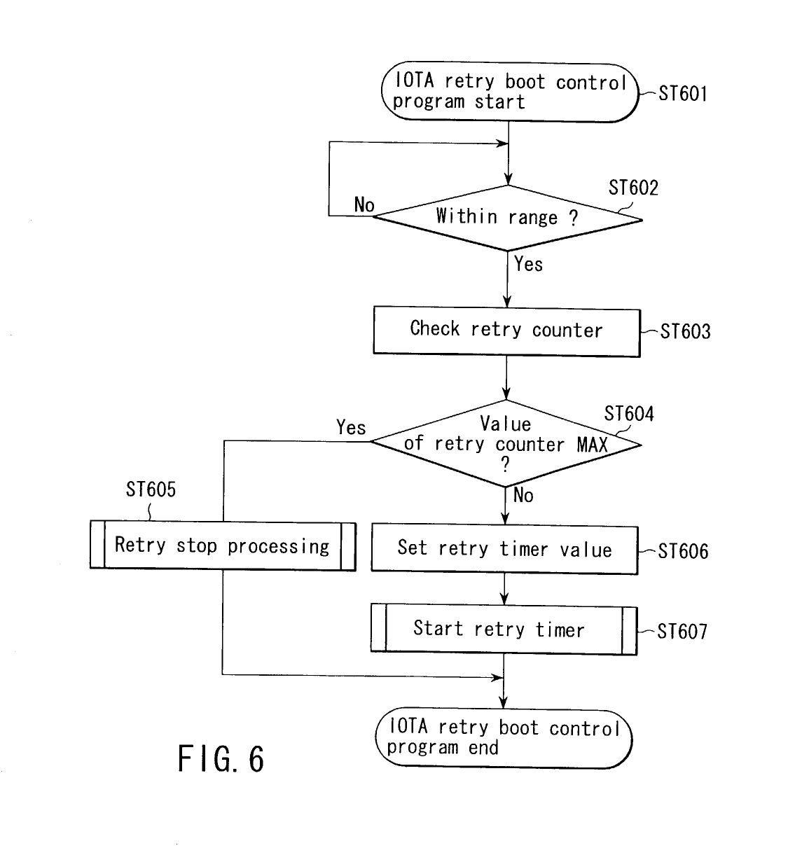

FIG. 6 is a flowchart showing a processing procedure and content of the IOTA retry boot control program. FIG. 6 shows the processing procedure and content of the IOTA retry boot control program executed in step ST309 of FIG. 3.

On receiving the execution request and starting the processing in step ST601, the controller 12 determines whether or not the present mobile communication terminal is in a system seizing state (ST602). That is, the controller 12 determines whether or not the terminal is within a communication range. The determination as to whether or not the terminal is within the communication range is determined by the quality of the radio signal detected. For example, a signal intensity (RSSI) is detected, and the radio signal quality is determined by the intensity. When the terminal is determined to be within the communication range, the processing advances to step ST603. On the other hand, when the terminal is determined not to be within the communication range, that is, out of the communication range, the controller 12 returns to step ST602. The controller determines whether or not the terminal is in the system seizing state.

Subsequently, in step ST603 a count value of a retry counter included in the controller 12 is read out, and it is determined in step ST604 whether or not the count value, that is, the number of retries of IOTA reaches a predetermined upper limit value. As a result of the determination, when the number of retries does not reach the upper limit value yet, the controller 12 shifts to step ST606 to set a given time to the retry timer, and starts the retry timer in step ST607.

Additionally, when the count value of the retry counter reaches the upper limit value, the controller 12 shifts to step ST605, and gives an execution request with respect to a retry stop control program described later in this step.

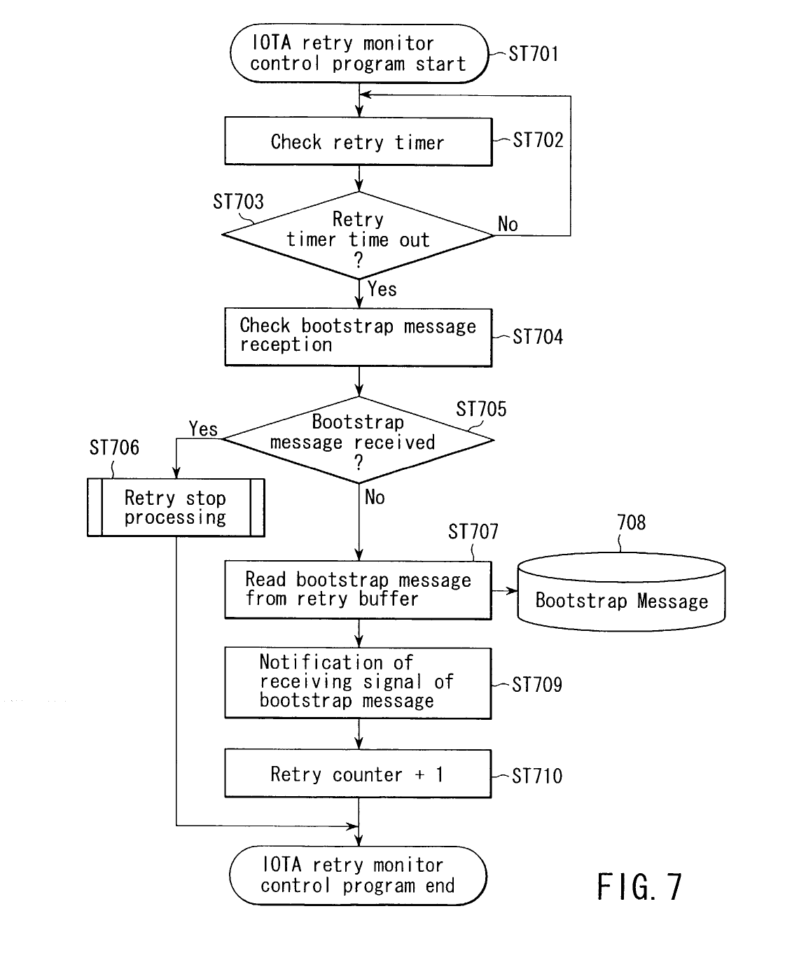

Additionally, separately from the processing of FIG. 6, the controller 12 executes an IOTA retry monitor control program. FIG. 7 is a flowchart showing a processing procedure and content of this IOTA retry monitor control program.

On starting an IOTA retry monitor processing in step ST701, the controller 12 first checks a count value of the retry timer in step ST702. It is determined in step ST703 whether or not the retry timer times out. When the retry timer times out as a result of determination, the controller 12 shifts to step ST704. Additionally, the checking of the count value and the determination processing are repeated, until the retry timer times out.

The controller 12 shifts to step ST704, first checks the reception of the bootstrap message in this step, and determines in step ST705 whether or not a new bootstrap message has been received from the server SV. As a result of the determination, when the new bootstrap message is received, the controller shifts to step ST706 and requires the execution of the IOTA retry stop control program. Subsequently, the retry monitor processing is ended without executing the retry of IOTA.

On the other hand, when the new bootstrap message is not received, the controller 12 shifts to step ST707, and reads the received and stored bootstrap message from a buffer for IOTA reboot (retry buffer 708). Subsequently, based on the bootstrap message read in step ST709, the main control program is notified of the reception of the bootstrap message. Thereafter, 1 is added to the value of the retry counter (ST710).

As a result, in the main control program, as shown in FIG. 3, after the IOTA status flag is set to “IOTA booted” in step ST304, a request processing for establishing the data communication link with the server SV is performed in step ST305, and therefore an IOTA download control processing is executed in step ST307. The procedure and content of this processing are the same as those shown in FIG. 5.

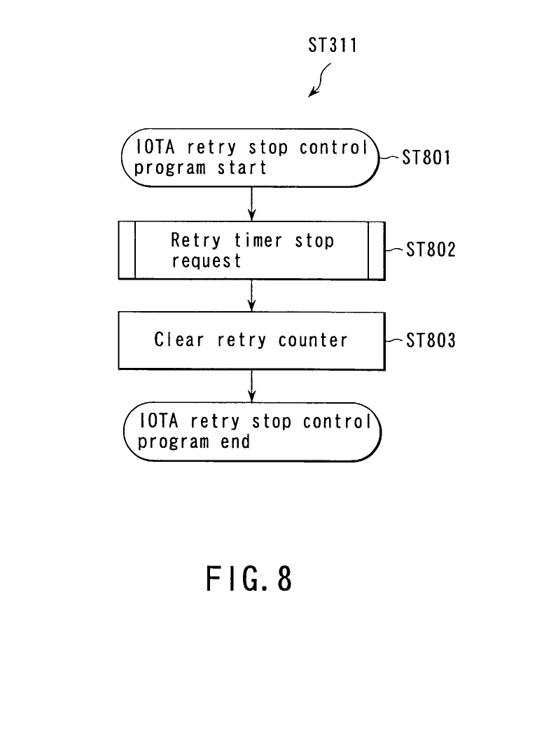

FIG. 8 is a flowchart showing a processing procedure and content of IOTA retry stop control program executed in step ST311 of FIG. 3, step ST411 of FIG. 4, step ST604 of FIG. 6, and step ST706 of FIG. 7.

On executing the IOTA retry stop control program, the controller 12 first stops the retry timer in step ST802 as shown in FIG. 8, and further clears the count value of the retry counter in step ST803. Moreover, after ending these processings, the controller returns to the idle state.

As described above, in the embodiment, when the server SV transfers the bootstrap message to the mobile communication terminal MS1, the bootstrap message is stored in a retry buffer of the mobile communication terminal MS1. Moreover, when the IOTA feature is discontinued before a download start or during download, IOTA is again executed based on the stored bootstrap message at a timing designated by the retry timer.

Therefore, according to the present embodiment, even when the IOTA is discontinued because of the connection failure of the data communication link, failure of the data download, and disconnection of the data communication link, IOTA is automatically re-executed in the mobile communication terminal MS1. Therefore, the mobile communication terminal MS1 can voluntarily resume the download processing of the system information without waiting for the retransmission of the bootstrap message from the server SV. Therefore, the mobile communication terminal MS1 can quickly acquire the latest system information.

Moreover, when the data download by IOTA fails, the server SV does not have to start the control with respect to the mobile communication terminal as a destination again, and this can reduce a control burden regarding the download of the system information.

Furthermore, in the embodiment, the retry counter counts the number of retries, and repeats the retry, until the number of retries reaches the upper limit value. Therefore, the retry of IOTA is automatically performed a plurality of times, and this can increase probability of IOTA being executed.

Additionally, in the embodiment, the arrival of the new bootstrap message from the server SV is monitored during the retry monitor control. When the new bootstrap message is received by the server SV, the retry control is failed, and IOTA is booted in accordance with the new bootstrap message. Therefore, the original boot request of IOTA from the server SV is not ignored, and accuracy of the download control of the system information by IOTA can maintain between the mobile communication terminal MS1 and server SV.

Therefore, according to the embodiment of the present invention, when the download feature of the system information is discontinued by connection failure of data communication link, failure of the downloading, or disconnection of the data communication link, the download request is transmitted to the server based on the boot message stored in the mobile communication terminal. Therefore, the mobile communication terminal can voluntarily resume the download processing of the system information without waiting for the retransmission of the boot message from the server. Thereby, the mobile communication terminal can quickly acquire the latest system information. Moreover, the server does not have to retry the control with respect to the mobile communication terminal which has failed in the download from the beginning. This can reduce a control burden regarding the download of the system information.

Concretely, the mobile communication terminal starts a timer, when the system information download function is detected to be failed. This timer monitors an elapse of a given time. With the elapse of the given time, the terminal retransmits the download request of the system information. In this case, with the failure of the system information download function, the mobile communication terminal can retransmit the download request before the server stops the download control. Therefore, the mobile communication terminal can smoothly start or resume the download of the system information.

Furthermore, the mobile communication terminal may repeat the retransmission of the download request in a predetermined period a fixed number of times, until the download of the system information is determined to be successful. In this case, for example, with a degraded quality of a radio channel, a probability that the mobile communication terminal can start or resume the download of the system information can be increased.

Moreover, the second reception control means monitors the arrival of a new boot message from the server, while the timer monitors the elapse of the given time. When the new boot message arrives, the means may stop the retransmission control of the download request and the first reception control means may operate. In this case, the mobile communication terminal does not ignore the original boot message from the server. Thereby, the mobile communication terminal can constantly exactly execute the download control of the system information with the server.

Moreover, the embodiment of the present invention is especially effective, when applied to the download of the system information by the mobile communication terminal. The system information is for use by the mobile communication terminal in seizing an appropriate system from a plurality of mobile communication systems.

It is to be noted that the embodiment of the present invention is not limited to the above-described embodiment, and can be applied, for example, to any type or structure of mobile communication terminal, and any structure of mobile communication system. Moreover, for an IOTA main control program, reception control program of the bootstrap message, IOTA download control program, IOTA retry boot control program, IOTA retry monitor control program, and IOTA retry stop control program, the processing procedures and contents can be variously modified and implemented without departing from the scope of the embodiment of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A method of downloading system information on a mobile communication system to a mobile communication terminal for use in the mobile communication system, the system information being downloaded to the mobile communication terminal from a server via a computer network and mobile communication network, the method comprising:
transmitting a boot message to the mobile communication terminal from the server;
storing the boot message transmitted from the server in the mobile communication terminal;
transmitting a download request of the system information to the server from the mobile communication terminal based on the boot message transmitted from the server;
downloading the system information to the mobile communication terminal from the server based on the download request transmitted from the mobile communication terminal;
detecting whether or not downloading the system information is failed;
retransmitting the download request of the system information to the server from the mobile communication terminal based on the boot message stored, when downloading the system information is detected to be failed; and
downloading the system information to the mobile communication terminal from the server based on the download request resent from the mobile communication terminal.

2. The method according to claim 1, wherein the system information includes visual data and audio data.

3. The method according to claim 1, wherein the system information includes information for use by the mobile communication terminal in seizing an appropriate system from a plurality of mobile communication systems.

4. A mobile communication terminal for use in a mobile communication system including a feature for downloading system information on the mobile communication system to the mobile communication terminal from a server via a computer network and mobile communication network, the mobile communication terminal comprising:
a reception part configured to receive a boot message sent by the server;
a storing part configured to store the boot message received by the reception part;
a first reception control part configured to transmit a download request of the system information to the server based on the boot message received by the reception part, and receive the system information downloaded from the server based on the download request;
a first detecting part configured to detect whether or not downloading of the system information is failed by the first reception control part; and
a second reception control part configured to resend the download request of the system information to the server based on the boot message stored in the storing part, when the first detecting part detects the downloading of the system information to be failed, and receive the system information downloaded from the server based on the download request retransmitted.

5. The mobile communication terminal according to claim 4, wherein the system information includes visual data and audio data.

6. The mobile communication terminal according to claim 4, wherein the first reception control part transmits the download request of the system information including information for use by the terminal in seizing an appropriate system from a plurality of mobile communication systems to the server, and receives the system information downloaded from the server based on the download request.

7. The mobile communication terminal according to claim 4, wherein the second reception control part starts a timer, when the first detecting part detects the downloading of the system information to be failed, the timer monitors an elapse of a given time, and the second reception control part retransmits the download request of the system information, when the given time elapses.

8. The mobile communication terminal according to claim 4, further comprising a second detecting part configured to detect whether or not the downloading of the system information by the second reception control part is successful, the second reception control part repeating the retransmission of the download request in a predetermined period a given number of times, until the second detecting part detects the downloading to be successful.

9. The mobile communication terminal according to claim 7, wherein the second reception control part has a feature of monitoring arrival of a new boot message from the server in a count term of the timer, stopping a retransmission control of the download request, when the new boot message arrives, and operating the first reception control part.

10. A method of downloading system information on a mobile communication system to a mobile communication terminal for use in the mobile communication system, the system information being downloaded to the mobile communication terminal from a server via a computer network and mobile communication network, the method comprising:
transmitting a download request of the system information to the server from the mobile communication terminal;
downloading the system information to the mobile communication terminal from the server based on the download request transmitted from the mobile communication terminal;
detecting whether or not downloading the system information is failed;
retransmitting the download request of the system information to the server from the mobile communication terminal, when downloading the system information is detected to be failed; and
downloading the system information to the mobile communication terminal from the server based on the download request retransmitted from the mobile communication terminal.

11. The method according to claim 10, wherein the system information includes visual data and audio data.

12. The method according to claim 10, wherein the system information includes information for use by the mobile communication terminal in seizing an appropriate system from a plurality of mobile communication systems.

13. A mobile communication terminal for use in a mobile communication system including a feature for downloading system information on the mobile communication system to the mobile communication terminal from a server via a computer network and mobile communication network, the mobile communication terminal comprising:
a first reception control part configured to transmit a download request of the system information to the server, and receive the system information downloaded from the server based on the download request;
a first detecting part configured to detect whether or not downloading of the system information by the first reception control part is failed; and
a second reception control part configured to retransmit the download request of the system information to the server, when the first detecting part detects the downloading of the system information to be failed, and receive the system information downloaded from the server based on the download request retransmitted.

14. The mobile communication terminal according to claim 13, wherein the system information includes visual data and audio data.

15. The mobile communication terminal according to claim 13, wherein the first reception control part transmits the download request of the system information including information for use by the terminal in seizing an appropriate system from a plurality of mobile communication systems to the server, and receives a system seizing preference list downloaded from the server based on the download request.

16. The mobile communication terminal according to claim 13, wherein the second reception control part starts a timer, when the first detecting part determines the downloading of the system information to be failed, the timer monitors an elapse of a given time, and the second reception control part retransmits the download request of the system information, when the given time elapses.

17. The mobile communication terminal according to claim 13, further comprising a second detecting part configured to detect whether or not the downloading of the system information by the second reception control part is successful, the second reception control part repeating retransmission of the download request in a predetermined period a given number of times, until the second detecting part detects the downloading to be successful.

18. A mobile communication terminal for use in a mobile communication system including a feature for downloading system information on the mobile communication system to the mobile communication terminal from a server via a computer network and mobile communication network, the mobile communication terminal comprising:
a reception part configured to receive a boot message sent by the server;
a storing part configured to store the boot message received by the reception part;
a first reception control part configured to transmit a download request of the system information to the server based on the boot message received by the reception part, and receive the system information downloaded from the server based on the download request;
a first detecting part configured to detect an error while the system information is downloaded; and
a second reception control part configured to resend the download request of the system information to the server based on the boot message stored in the storing part, when the first detecting part detects the error, and receive the system information downloaded from the server based on the download request retransmitted.
